(19) United States
(12) Patent Application Publication
(10) Pub. No.: US 2004/0152044 A1
(43) Pub. Date: Aug. 5, 2004

(54) Dental forceps for tooth extraction

(76) Inventor: Russell Khan-Sullman, London (GB)

Correspondence Address: Thomas M. Freiburger, P O Box 1026, Tiburon, CA, 94920, US

(21) Appl. No.: 10/476,050

(22) PCT Filed: Mar. 22, 2002
(86) PCT No.: PCT/GB02/01394

(30) Foreign Application Priority Data
Apr. 28, 2001 (GB) 0109932.4

(51) Int. Cl. A61C 3/14

(52) U.S. Cl. 433/159

(57) ABSTRACT

Dental forceps for tooth extraction comprise a pair of jaw members (2, 3) and a pair of handle members (5, 6). The jaw members (2, 3) are designed to be inserted into the mouth of a patient to grip a tooth and for this purpose they are pivotable with respect to each other about a pivot axis 4. The handle members (5, 6) are rigidly connected to the jaw members (2, 3) so that movement of the handle members towards and away from each other causes corresponding closing and opening of the gap between the jaw members (2, 3). The handle members (5, 6) have portions extending in directions at least components of which are parallel to the pivot axis (4).

This invention relates to dental forceps for tooth extraction.

While dental forceps designed for the purpose of tooth extraction have been in existence for centuries a number of factors, including the small human mouth, fleshy cheeks and a restless tongue can make tooth extraction a difficult procedure to undertake. Molar teeth situated towards the back of the mouth, and in particular wisdom teeth, are especially difficult to deal with.

The current design of existing dental forceps is such that during tooth extraction, particularly molars, a great deal of force is exerted against and upon the corner of the mouth and cheeks of the patient, and—to gain suitable access and an acceptable grip—the patient's mouth has to be kept very wide open which can have detrimental effects upon the TMJ joint and upon the associated hard and soft tissues of the mouth and oral cavity.

It is an object of the invention to provide a design of dental forceps which are easier for dentists to use and which causes less discomfort for their patients.

According to the invention dental forceps for tooth extraction comprise a pair of jaw members and a pair ofhandle members each of which is rigidly connected to a respective jaw member, wherein the jaw members are pivotable with respect to each other about a common pivot axis, and wherein the handle members have portions extending in directions at least components of which are parallel to the pivot axis.

Preferably said common pivot axis extends through hub portions of the jaw members, and the handle members have hub adjacent portions close to the pivot axis and end portions positioned away from the pivot axis and an angular bend between the hub adjacent portions and the end portions. The angle of the bend may be approximately 90° or else be greater than or less than 90°.

The handle members may be non-rectilinear.

The hub adjacent portions of the handle members may extend generally parallel to the pivot axis. Alternatively the hub adjacent portions of the handle members may lie in a plane perpendicular to the pivot axis.

By way of example, embodiments of the invention will now be described with reference to the accompanying drawings in which:

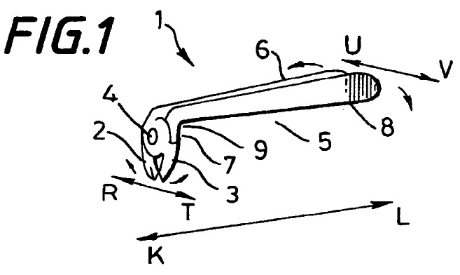

FIG. 1 is a perspective view of a dental forceps embodying the invention,

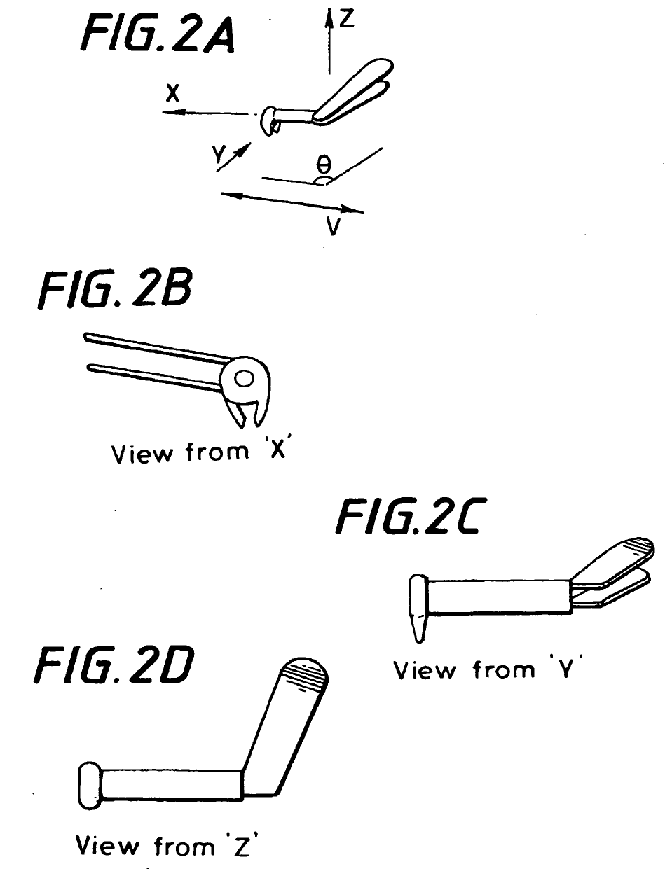

FIG. 2 shows at (A) a perspective view of an alternative embodiment of the invention, and at (B), (C) and (D) directional views of that embodiment in the directions marked X, Y and Z respectively,

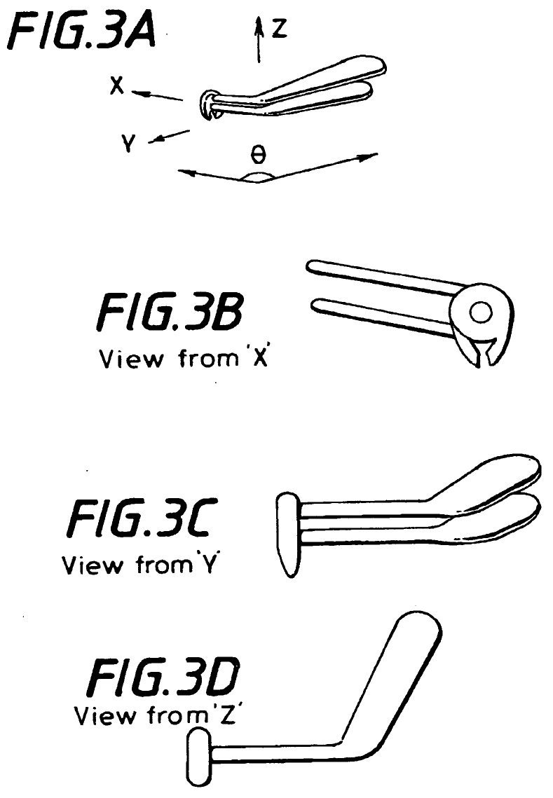

FIG. 3 shows at (A) a perspective view of another alternative embodiment of the invention, and at (B), (C) and (D) directional views of that embodiment in the directions marked X, Y and Z respectively,

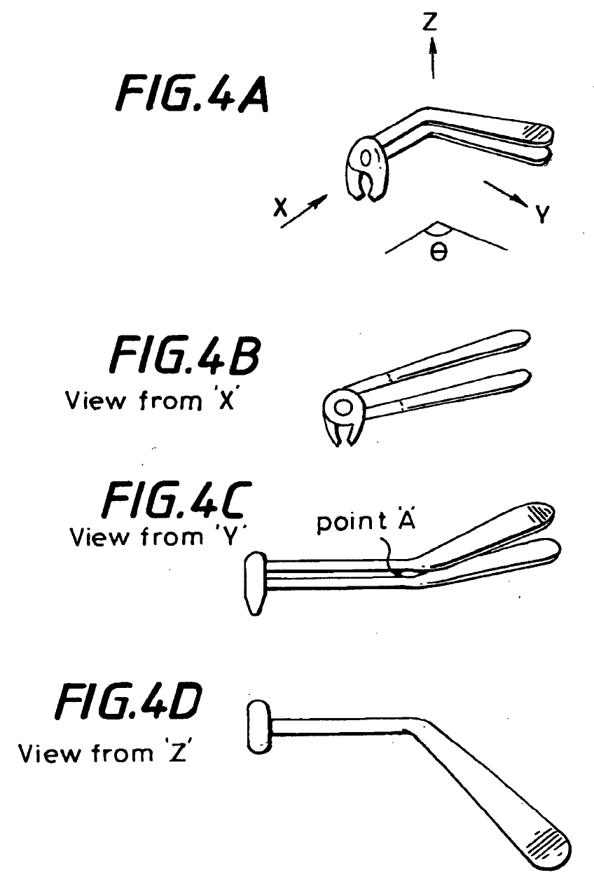

FIG. 4 shows at (A) a perspective view of yet another alternative embodiment of the invention, and at (B), (C) and (D) directional views of that embodiment in the directions marked X, Y and Z respectively,

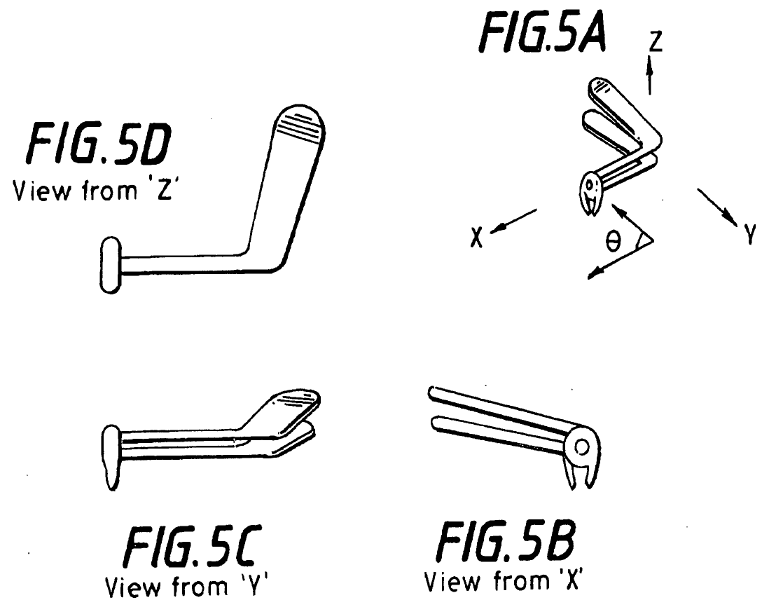

FIG. 5 shows at (A) a perspective view of still another alternative embodiment of the invention, and at (B), (C) and (D) directional views of that embodiment in the directions marked X, Y and Z respectively,

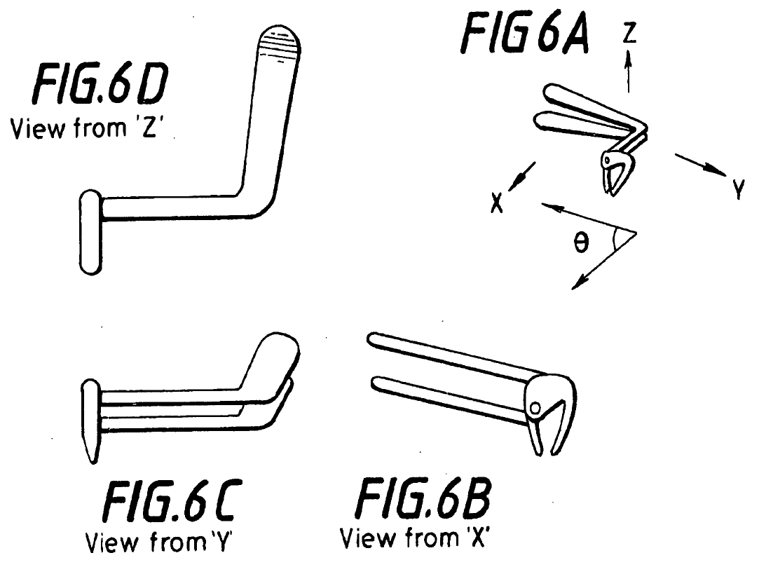

FIG. 6 shows at (A) a perspective view of yet another alternative embodiment of the invention, and at (B), (C) and (D) directional views of that embodiment in the directions marked X, Y and Z respectively, and

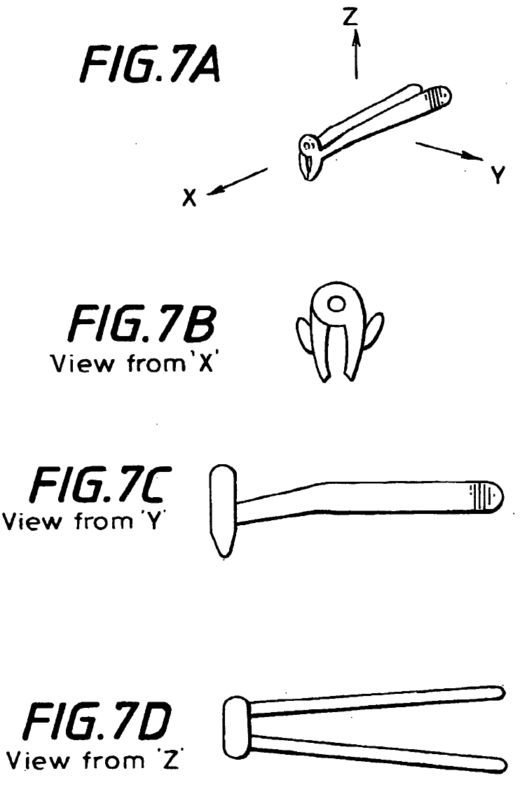

FIG. 7 shows at (A) a perspective view of yet another alternative embodiment of the invention, and at (B), (C) and (D) directional views ofthat embodiment in the directions marked X, Y and Z respectively.

Referring now to FIG. 1 there is shown therein a dental forceps 1 having a pair of jaw members 2 and 3. Jaw members 2 and 3 are pivotable with respect to each other about a common pivot axis. A pivot member 4, which can be either independent of jaw members 2 and 3 or else integral with one of the jaw members, extends along the common pivot axis. A pair of handle members 5 and 6 are provided to operate jaw members 2 and 3 and for this purpose each handle member is rigidly connected to a respective jaw member. Handle member 5 is rigidly connected to jaw member 2 and handle member 6 is rigidly connected to jaw member 3.

Handle members 5 and 6 are shaped to be non-rectilinear. Considering handle member 5 as exemplary, it has a hub portion 7 close to pivot 4 and an end portion 8 positioned away from pivot 4 with an angular bend 9 between portions 7 and 8. As shown in FIG. 1, the angle of bend 9 is approximately 80°. However bend 9 can be less than or greater than that value and in general less than, equal to or greater than 90°. Handle member 6 is similarly shaped. It will be seen from FIG. 1 that bends in the handle members are such that the end portions of the handle members extend in directions which have at least components generally parallel to the pivot axis.

It will be seen that in use of the dental forceps of FIG. 1 a line RT is traced out by the movement of the ends of the jaws 2 and 3. Corresponding movement of the ends of the handle members 5 and 6 to bring about movement of jaw members 2 and 3 follows a line UV. The pivot axis of the forceps is parallel to line KL. Lines RT and UV are parallel to each other but not parallel to line KL.

The dental forceps shown in FIG. 1 are particularly effective in posterior tooth extraction. The approach of the practitioner can be from the front of the patient for extracting a wisdom tooth and not from the side as when using conventional forceps.

An alternative form of dental forceps embodying the invention is shown in FIG. 2(A). Like parts of the embodiment of FIG. 2(A) have like reference numerals to the embodiment that is shown in FIG. 1. However in FIG. 2(A), the pivot 4 is extended along the line of the pivot axis to form an elongated hinge-type mechanism Three mutually orthogonal directions X, Y and Z are marked in FIG. 2(A). FIG. 2(B) is a view of the forceps in direction X, FIG. 2(C) is a view of the forceps in direction Y and FIG. 2(D) is a view of the forceps in direction Z. Also marked in FIG. 2(A) is the plane XY on which is indicated the angle δ which is the angular bend between the hub adjacent portions of the handles in line with the pivot axis and the end portions of the handles. The angle θ corresponds to the angular bend 9 in the embodiment of FIG. 1.

In the embodiment shown in the various views of FIG. 2, the ends of the handle members, which are the parts of the handles that are grasped by a practitioner when the forceps are being used, are not in line with the jaw members although they can be substantially parallel thereto. The forceps can therefore readily be used to grasp a tooth for extraction whilst the handles where the grasping takes place are sufficiently removed from a patient's mouth so as not to impinge or put pressure upon the patient's cheek and associated tissues.

A similar effect to the forceps shown in FIG. 2 can also be obtained by retaining a short pivot member as shown in FIG. 1 and instead extending the hub adjacent portions of the handles in the direction of the pivot axis. Such an arrangement is shown in FIG. 3 at (A), (B), (C) and (D) which correspond to the similarly numbered figures in FIG. 2. In the case of the arrangement shown in FIG. 3 the hub adjacent portions of the handles remain inside the patient's mouth and care must therefore be taken in their design so that they do not trap or traumatise soft tissue.

With various modifications of the examples of dental forceps embodying the invention shown in FIGS. 1, 2 and 3 it becomes possible for a dental practitioner to extract a tooth from anywhere in the mouth without having to change his position relative to the patient.

A further advantage is that dental forceps embodying the invention can be designed for either right-handed or left-handed use. Examples of such forceps are illustrated in FIG. 4 and FIG. 5. In FIG. 4 there is shown in perspective at (A) a dental forceps suitable for a right-handed dental surgeon and designed for the extraction of a lower second molar tooth. Directions X, Y and Z are marked in FIG. 4(A) and views of the dental forceps shown in FIG. 4(A) as seen in each of these directions are shown in FIGS. 4(B), 4(C) and FIG. 4(D) respectively.

As shown more clearly in FIG. 4(C) the handle members have hub adjacent portions close to the pivot axis and end portions positioned away from the pivot axis and a small angular bend between the hub adjacent portions and the end portions. The hub adjacent portions extend in directions which are parallel to the pivot axis. In operation of the handle members to open and close the jaw members it will be seen that while the hub adjacent portions of the handles rotate they move very little with respect to each other. Thus a protective sheath of soft material, such as rubber or the like, can be provided around the hub adjacent portions of the handles. This is particularly useful in preventing parts of the mouth of a patient being trapped between the handles since it is the hub adjacent portions of the handles that will be required to be inserted in the mouth of the patient.

In FIG. 5 there is shown in perspective at (A) a dental forceps suitable for a left-handed dental surgeon and also designed for the extraction of a lower molar tooth. Similarly to FIG. 4(A) directions X, Y and Z are marked in FIG. 5(A) and views of the dental forceps shown in FIG. 5(A) as seen in each of these directions are shown in FIGS. 5(B), 5(C) and FIG. 5(D) respectively.

FIG. 6 illustrates a similar embodiment with like functions but with an alternate position for the pivot to allow the user better vision of the oral cavity and the tooth being extracted.

FIG. 7 shows at (A) a perspective view of a yet another embodiment of the invention having handle members 71 and 72 and jaw members 73 and 74. Jaw members 73 and 74 are pivotally secured to each other at a pivot 75. Handle members 71 and 72 are secured to jaw members 73 and 74 at positions along jaw members 73 and 74 which are between pivot 75 and the ends of jaw members 73 and 74. As shown more clearly in the view of FIG. 7(D) handle members 71 and 72 are not parallel to each other but diverge at a small angle from each other. However if preferred handle members 71 and 72 can be constructed to be parallel to each other. Additionally, as shown more clearly in FIG. 7(C) each handle member 71 or 72 is provided with a small bend. However this feature is optional and handle members 71 and 72 can be straight if preferred.

In a modification applicable to one or more of the above-described and illustrated embodiments of the invention, a protective cover of generally tubular form may be placed over the hub adjacent portions of the handle members to minimise risk of damage to other teeth during a tooth extraction.

Although the above-described and illustrated embodiments of the invention are primarily for molar extraction, they can be used for non-molar teeth and for removal of dental debris.

It will be appreciated that the above-described and illustrated embodiments of the invention can be used by a dental surgeon without him/her having to shift position to any substantial degree (if at all) if the tooth to be removed is to the left or right side of the mouth. Thus, for example, the dental surgeon can remain seated behind and to the right of the patient even, say, when extracting a lower left molar tooth.

Additionally or alternatively, forceps according to any one of the above-described and illustrated embodiments of the invention can be provided both as shown and as ‘mirror-image’ formations thereby to suit right-handed or left-handed practitioners. Nevertheless the same type of forceps could be used by both type of practitioner, i.e. a right-handed practitioner may be able to use a left-handed forceps, if necessary.

Other modifications and embodiments of the invention, which will be readily apparent to those skilled in this art, are to be deemed within the ambit and scope of the invention, and the particular embodiments hereinbefore described may be varied in construction and detail, e.g. interchanging (where appropriate or desired) different features of each, without departing from the scope of the patent monopoly hereby sought and defined in the following claims.

1. Dental forceps for tooth extraction comprising a pair of jaw members and a pair of handle members each of which is rigidly connected to a respective jaw member, wherein the jaw members are pivotable with respect to each other about a common pivot axis, and wherein the handle members have portions extending in directions at least components of which are parallel to the pivot axis.

2. Dental forceps as claimed in claim 1 in which the handle members are non-rectilinear.

3. Dental forceps as claimed in claim 1 or claim 2 in which said common pivot axis extends through hub portions of the jaw members, and the handle members have hub adjacent portions close to the pivot axis and end portions positioned away from the pivot axis and an angular bend between the hub adjacent portions and the end portions.

4. Dental forceps as claimed in claim 3 in which the angle of the bend is approximately 90°.

5. Dental forceps as claimed in claim 3 in which the angle of the bend is greater than 90°.

6. Dental forceps as claimed in claim 3 in which the angle of the bend is less than 90°.

7. Dental forceps as claimed in any one of the preceding claims in which the hub adjacent portions of the handle members extend generally parallel to the pivot axis.

8. Dental forceps as claimed in any one of the preceding claims in which the hub adjacent portions of the handle members lie in a plane perpendicular to the pivot axis.

9. Dental forceps as claimed in claim 1 or claim 2 in which the handle members are connected to the jaw members at positions lying between the pivot axis and the ends of the jaw members.

10. Dental forceps for tooth extraction substantially as described herein with reference to any one of the figures of the accompanying drawings.
